(19) United States
(12) Patent Application Publication
(10) Pub. No.: US 2005/0013991 A1
(43) Pub. Date: Jan. 20, 2005

(54) Three-dimensional colour pattern slabs which formed by sintering ceramic powder

(76) Inventor: Dening Yang, Guangdong (CN)

Correspondence Address: FISH & RICHARDSON PC, 225 FRANKLIN ST, BOSTON, MA, 02110, US

(21) Appl. No.: 10/489,155

(22) PCT Filed: Sep. 9, 2002
(86) PCT No.: PCT/CN02/00632

(30) Foreign Application Priority Data
Sep. 10, 2001 (CN) 01127837.4

(51) Int. Cl. B32B 7/00

(52) U.S. Cl. 428/325; 428/210

(57) ABSTRACT

This invention relates to a the 3D color pattern slab formed by sintering ceramic powder, which is formed by pressing and sintering ceramic powders with minimum diameter of 0.1 mm-0.8 mm to provide a 3D color pattern slab formed by sintering ceramic powder, which is characterized in that, the ceramic product includes clear cut ceramic sintered pattern regions having 2-10 various kinds of colors or different shades of a single or mixed colors; at least 2 types of pattern regions each occupies 10%-90% of the total area of the ceramic product, in which at least each pattern region having at least one type of colored ceramic powder uniformly distributed in 80%-100% of the pattern area and 70%-100% from surface to the inside 70%-100% of the thickness of the ceramic product; also, in a 1 mm-20 mm intersecting region between said two types of colored pattern regions, the mixture ratio of the different colored powder material between two different color pattern regions can reach from 1:50 to 50:50. In this way imitation stone slab imitating natural stone in 3D space, with virtues of lower water absorption, less color difference, and higher degree of smoothness, and free of radioactive contamination etc.

### FIELD OF THE INVENTION

The present invention relates to an imitation stone slab used as building material in the field of ceramic industry, and more particularly, to a 3D (three dimensional) color pattern slab formed by sintering ceramic powder belong to the family of stone pattern imitation slabs used for decorating permanent floor, wall and furniture facing. The slab is obtained by pressing and sintering of colorized ceramic powders forming clear-cut pattern regions comprising various colors or various shades of same color or mixed colors. The pattern regions are uniformly distributed from surface to 70%-100% of the thickens of the slab, forming a 3D imitation stone exactly like a natural stones lab, having pattern configuration more like a natural stone slab compared with an existing imitation stone slab, with lower water absorption, less color difference, and higher degree of smoothness, and free of radioactive contamination compared with a natural stones lab, therefore suitable for industrial application with its practicability and novel design.

### BACKGROUND OF THE INVENTION

With the development of technology and people's living standard, people may expect the decorative slabs for floor and walls to have an appearance of a natural stone, for example, a granite, to increase the sense of beauty.

Continuous attempts have been made to improve the structure of imitation decorative stone slabs by the industry. The present inventor holds several patents concerning decorative slabs, one of them relates to a process for producing stereo ceramic granite and marble, international publication No. WO97/36840, published on Oct. 9, 1997, which discloses an imitation stone slab having clear-cut patterns on the slab surface which will not change when the slab surface is processed so as to effectively improve the stability of the whole structure when such a slab is put into use. However, this prior art imitation stone slab has vertical boundary lines formed between different patterns, so the transition between colored patterns does not provide a natural look as that of a real stone slab, which is still not what is expected.

In order to satisfy the need for practicability, the present inventor has later disclosed a ceramic imitation granite slab and its making method in his application entitled as Ceramic Imitation Granite Slab and Method Thereof, Publication No. WO99/28262, published on Jun. 10, 1999, which do has some improvement, however, defects is found in the structure of said ceramic imitation granite slab during use, that the slab made according to said method can only provides a pattern on the surface of said imitation slab instead of a 3d pattern, not able to reflect the quality of natural granite of which the pattern is formed from inside to the outside. Especially the middle and lower part of the edge of said imitation slab does not show any patterns. If such a slab is used for decoration of table tops or walls and pillars where edge trimming and grinding are required, it will not give a natural and complete look like a natural stone slab because the edge region of the slab does not have the granule patterns same as that of the surface region of the slab.

The decorative imitation slab of prior art with random distributed granular materials has disordered 3d patterns from the surface to the inside of the slab, therefore it cannot form uniform patterns from the surface to the inside like that of a natural stone slab to give an ‘clone’ effect to a natural stone slab.

From the above description one can not that all prior art stone slabs do not provide exact imitation of the colored granular patterns of the natural granite, which is obvious an defect that requires improvement.

### BRIEF SUMMARY OF THE INVENTION

It is an object of this invention to overcome the defects of the existing decorative imitation stone slabs and provide a 3D color pattern slab formed by sintering ceramic powder by providing an imitation stone material, or referred to as ‘clone natural stone material’, which has an 3D structure exactly like that of a natural stone material as a novel slab product. Local distribution of density and locations of colorized inorganic silicate raw materials inside the 3D space of the imitation product according to the present invention can be controlled and produced according to that of patterns of natural stone materials so as to provide a better imitation of the natural stone materials.

It is another object of the present invention to provide a 3D color pattern slab formed by sintering ceramic powder to provide a better imitation of natural stone materials by forming a controlled uniform 3D density distribution of of granules formed by colored powder material.

It is yet another object of the present invention to provide a 3D color pattern slab formed by sintering ceramic powder which has advantages including lower water absorption, less color difference for large regions, higher degree of smoothness, better geometric sizes, and free of radioactive contamination compared with a natural stone slab.

The object of the present invention can be achieved by the following technical solutions. A ceramic product is formed by pressing and sintering ceramic powders with minimum diameter of 0.1 mm-0.8 mm to provide a 3D color pattern slab formed by sintering ceramic powder, which is characterized in that, the ceramic product includes clear cut ceramic sintered pattern regions having 2-10 various kinds of colors or different shades of a single or mixed colors; at least 2 types of pattern regions each occupies 10%-90% of the total area of the ceramic product, in which at least each pattern region having at least one type of colored ceramic powder uniformly distributed in 80%-100% of the pattern area and 70%-100% from surface to the inside 70%-100% of the thickness of the ceramic product; also, in a 1 mm-20 mm intersecting region between said two types of colored pattern regions, the mixture ratio of the different colored powder material between two different color pattern regions can reach from 1:50 to 50:50.

The objects of the present invention can be further achieved by the following techniques:

Said 3D color pattern slab formed by sintering ceramic powder, wherein said slab comprises at least 2 types of colored pattern regions each occupies 10%-90% of the total slab region, and each pattern region including at least a kind of color powder within 80%-100% of the area of that pattern region is uniformly distributed from the surface to the inside of the slab in 85%-100% of its thickness.

Said 3D color pattern slab formed by sintering ceramic powder, wherein an intersecting region of 1-20 mm in between said 2 types of colored pattern regions has mixture ratio from 1:50 to 50:50 of the different color powders of said 2 colored pattern regions, and the independent color powder with minimum diameter of 0.1 mm -0.8 mm in the intersectional region is 50′-100%.

Said 3D color pattern slab formed by sintering ceramic powder, wherein in a 1 mm-50 mm intersecting region between said two types of colored pattern regions, the mixture ratio of the different colored powder material between two different color pattern regions can reach from 1:50 to 50:50.

Said 3D color pattern slab formed by sintering ceramic powder, wherein said pattern regions have 1-5 kinds of ceramic granules with minimum diameter of 1.5 mm-20 mm with volume of said ceramic granules accounts for 2%-80% of the total volume of said pattern region.

Said 3D color pattern slab formed by sintering ceramic powder, wherein said clear cut ceramic sintered pattern regions formed by 2-10 various colors or various shades of same color or mixed colors are provided with 1-5 kinds of granule patterns composed of colored ceramic powders with diameter between 3 mm-60 mm in a 3D space from the surface to the 90%-100% of the thickness of the slab.

Said 3D color pattern slab formed by sintering ceramic powder, wherein said pattern regions can be colored regions composed of powders of solid colors such as red, yellow, white, blue, black, green, purple, or brown, etc., or mixed colors by combination of various powders of more than one color, or combination of mixed color with solid colors.

Said 3D color pattern slab formed by sintering ceramic powder, wherein said ceramic product has a surface that can be either a unpolished surface or a polished surface.

Said 3D color pattern slab formed by sintering ceramic powder, wherein said surface of the ceramic product can be further combined with rough slip-proofing patterns having depth of dented sections of 0.1 mm-5 mm to form a pattern structure having a more stereoscopic appearance, and the protruded sections can have a surface either unpolished or polished.

Said 3D color pattern slab formed by sintering ceramic powder, wherein said colorized inorganic silicates can be of any of the follow geometric configurations: flat, cylindrical, curved, partially cylindrical, spherical, multi-angular, round, elongated, or square, etc.

The present invention has obvious advantages and virtues compared with prior art. From the above description one can know that the 3D color pattern slab according to the present invention does not have the defects of the existing imitation stone slabs, and the construction according to the present invention is more stable and has more varieties. Detailed description of the virtues of present invention is given hereunder.

1. Said 3D color pattern slab formed by sintering ceramic powder according to the present invention, which is characterized in that, at least 2 types of pattern regions each occupies 10%-90% of the total area of the ceramic product, in which at least each pattern region having at least one type of colored ceramic powder uniformly distributed in 80%-100% of the pattern area and 70%-100% from surface to the inside 70%-100% of the thickness of the ceramic product; also, in a 1 mm-20 mm intersecting region between said two types of colored pattern regions, the mixture ratio of the different colored powder material between two different color pattern regions can reach from 1:50 to 50:50. By this structure a novel slab that has an imitation of natural stone in 3D space to give an real ‘clone’ of nature stone making local distribution of density and locations of colorized inorganic silicate raw materials inside the 3D space of the imitation slab according to the present invention controlled and produced according to local distribution of density of patterns of natural stone materials so as to provide a better imitation of the natural stone materials.

2. Said 3D color pattern slab formed by sintering ceramic powder according to the present invention can have a better imitation of a natural stone slab by density distribution structure by forming a controlled uniform 3D density distribution of granules formed by colored powder material.

3. The present invention is an improvement to the structure of the decorative imitation slabs of natural stone slabs with simple structure having relatively low cost for production. Compared with its virtues and practicability the present invention provides high value in use in the industry.

4. Said 3D color pattern slab formed by sintering ceramic powder according to the present invention has lower water absorption, less color difference, and higher degree of smoothness, and free of radioactive contamination compared with a natural stone slab with regard to environmental protection, therefore it is suitable for industrial application with its practicability by provide better choices for consumer.

As described above, said 3D color pattern slab formed by sintering ceramic powder according to the present invention has an better imitation of a natural stone slab compared with all prior arts in reproducing the pattern structure of the natural stone slab, at the same time, has lower water absorption, less color difference, and higher degree of smoothness, and free of radioactive contamination compared with a natural stone slab.

Detailed description of present invention with reference to exemplary embodiments and drawings is given hereunder.

### BRIEF DESCRIPTION OF THE DRAWINGS

FIG. 1 is a diagrammatic view of the planar construction of the 3D color pattern slab formed by sintering ceramic powder of the first embodiment according to the present invention.

FIG. 2 is a partial enlarged view of the boundary line between different color regions on the 3D color pattern slab formed by sintering ceramic powder of the first embodiment according to the present invention.

FIG. 3 is a vertical section view of the boundary line between different color regions on the 3D color pattern slab formed by sintering ceramic powder of the first embodiment according to the present invention.

FIG. 4 is a diagrammatic view of the planar construction of the steel die orifice for the 3D color pattern slab formed by sintering ceramic powder of the first embodiment according to the present invention.

### DETAILED DESCRIPTION OF THE INVENTION

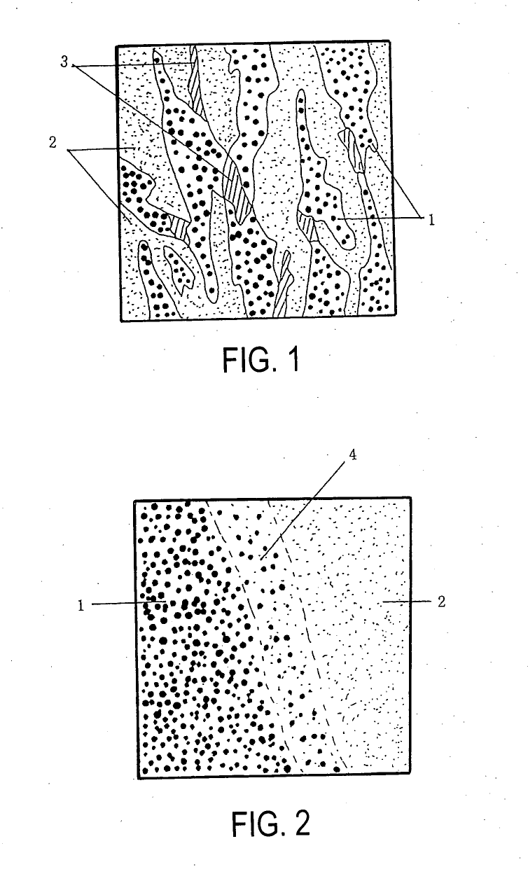

Refer to FIG. 1, is a diagrammatic view of the planar construction of the 3D color pattern slab formed by sintering ceramic powder of the first embodiment according to the present invention. In FIG. 1, portions covered with large black dots are orange color region 1 of a ceramic material; portions covered with small black dots are white color region 2 of a ceramic material; portions covered with oblique lines are gray-black color region 3 of a ceramic material

Now refer to FIG. 2, which is a partial enlarged view of the boundary line between different color regions on the 3D color pattern slab formed by sintering ceramic powder of the first embodiment according to the present invention. In FIG. 2, a portion covered with large black dots is orange color region 1 of a ceramic material; a portion covered with small black dots is white color region 2 of a ceramic material. The portions between two dotted lines is a transition region 4 formed by natural mix of orange colored powder of orange color region 1 to the white colored powder of the white color region 2 and vice versa. The mixing ratio of the transition region 4 is from 10:50 to 30:50.

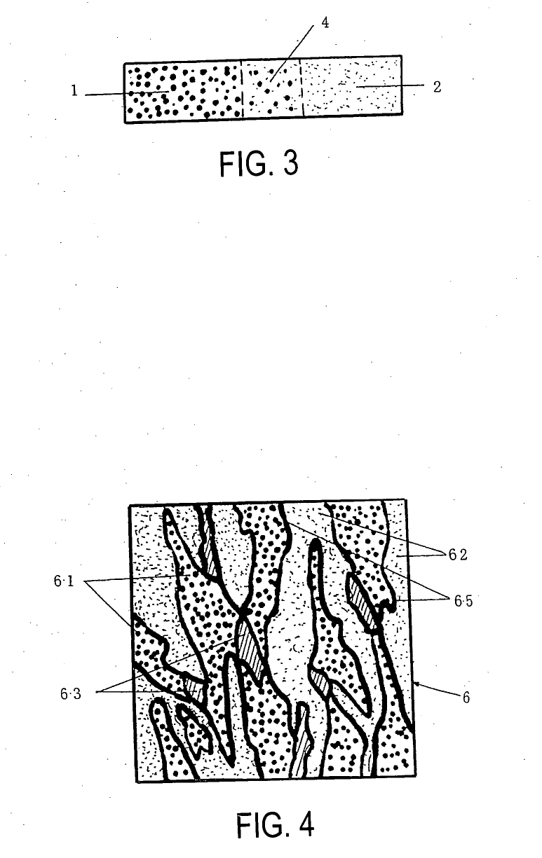

Now refer to FIG. 3, which is a vertical section view of the boundary line between different color regions on the 3D color pattern slab formed by sintering ceramic powder of the first embodiment according to the present invention. The portion covered with large black dots is orange color region 1 of a ceramic material; a portion covered with small black dots is white color region 2 of a ceramic material. The portion between two dotted lines is a transition region 4 formed by natural mix of two ceramic powders of different colors. The mixing ratio of the transition region 4 is from 10:50 to 30:50.

FIG. 4 is a diagrammatic view of the planar construction of the mold 6 with steel die orifices for the 3D color pattern slab formed by sintering ceramic powder of the first embodiment according to the present invention. Portions with large black dots are die orifices 61 for passing ceramic powder of orange color; portions with small black dots are die orifices 62 for passing ceramic powder of white color; portions with oblique lines are die orifices 63 for passing ceramic powder of gray-black color; bold lines denote the positions of steel die orifice plane 65 viewing from above to the bottom.

Refer to FIG. 1 through FIG. 4, the 3D color pattern slab formed by sintering ceramic powder, which is formed by pressing and sintering ceramic powders with minimum diameter of 0.1 mm-0.8 mm to provide a 3D color pattern slab formed by sintering ceramic powder, which is characterized in that, the ceramic product includes clear cut ceramic sintered pattern regions having 2-10 various kinds of colors or different shades of a single or mixed colors; at least 2 types of pattern regions each occupies 10%-90% of the total area of the ceramic product, in which at least each pattern region having at least one type of colored ceramic powder uniformly distributed in 80%-100% of the pattern area and 70%-100% from surface to the inside 70%-100% of the thickness of the ceramic product; also, in a 1 mm-20 mm intersecting region between said two types of colored pattern regions, the mixture ratio of the different colored powder material between two different color pattern regions can reach from 1:50 to 50:50.

In the process of producing the product according to the present invention, said 3D color pattern slab formed by sintering ceramic powder, wherein said slab comprises at least 2 types of colored pattern regions each occupies 10%-90% of the total slab region, and each pattern region including at least a kind of color powder within 80%-100% of the area of that pattern region is uniformly distributed from the surface to the inside of the slab in 85%-100% of its thickness.

In the process of producing the product according to the present invention, said 3D color pattern slab formed by sintering ceramic powder, wherein an intersecting region of 1-20 mm in between said 2 types of colored pattern regions has mixture ratio from 1:50 to 50:50 of the different color powders of said 2 colored pattern regions, and the independent color powder with minimum diameter of 0.1 mm -0.8 mm in the intersectional region is 50%-100%.

In the process of producing the product according to the present invention, said 3D color pattern slab formed by sintering ceramic powder, wherein in a 1 mm-50 mm intersecting region between said two types of colored pattern regions, the mixture ratio of the different colored powder material between two different color pattern regions can reach from 1:50 to 50:50.

In the process of producing the product according to the present invention, said 3D color pattern slab formed by sintering ceramic powder, wherein said pattern regions have 1-5 kinds of ceramic granules with minimum diameter of 1.5 mm-20 mm with volume of said ceramic granules accounts for 2%-80% of the total volume of said pattern region.

In the process of producing the product according to the present invention, said 3D color pattern slab formed by sintering ceramic powder, wherein said clear cut ceramic sintered pattern regions formed by 2-10 kinds of various colors or various shades of same color or mixed colors are provided with 1-5 kinds of granule patterns composed of colored ceramic powders with diameter between 3 mm-60 mm in a 3D space from the surface to the 90%-100% of the thickness of the slab.

In the process of producing the product according to the present invention, said 3D color pattern slab formed by sintering ceramic powder, wherein said colorized inorganic silicates may have an area from 40 cm²like mosaic to10 m² like huge stone materials with thickness of 3 mm-1000 mm and can be of any of the follow geometric configurations: flat, cylindrical, curved, partially cylindrical, spherical, multi-angular, round, elongated, or square, etc.

In the process of producing the product according to the present invention, said 3D color pattern slab formed by sintering ceramic powder, wherein said ceramic product has a surface that can be either a unpolished surface or a polished surface.

In the process of producing the product according to the present invention, said 3D color pattern slab formed by sintering ceramic powder, wherein said surface of the ceramic product can be further combined with rough slip-proofing patterns having depth of dented sections of 0.1 mm-5 mm to form a pattern structure having a more stereoscopic appearance, and the protruded sections can have a surface either unpolished or polished.

Now the method and process of producing the said 3D color pattern slab formed by sintering ceramic powder of the first embodiment according to the present invention is described as follows:
(1). Put powder raw materials including 50%-90% of small granules with diameter of 0.25 mm-0.8 mm of orange color 1, white color 2, and black color 3 for ceramic slabs into three vessels respectively;
(2). Then put a set of mold assembly 4 having die orifices for three color regions with desired patterns under the vessels;
(3). Fill the raw materials of various color into the desired regions according to FIG. 4 respectively;
(4). Move the steel mold 6 with high speed in four directions on a plane within an range of 1-20 mm. The moving speed is 0.5-10 times of the free falling speed of the ceramic powder to form a natural mixing at the boundary line between different color regions, forming a real imitation of the 3D structure of a natural stone by make the granules fall into the combined press mold frame of press machine through die orifice of according the predetermined pattern.

(5). Then shape by pressing with press machine, followed sinter the dried mass to the end product.

The above described are only the preferred embodiments of the present invention which does not in any way limit the present invention. It should be appreciated that any modifications or changes may be made according to the preferred embodiments of the present invention without departing from the scope of technical solutions described herein.

INDUSTRIAL APPLICABILITY

1. A 3D color pattern slab formed by sintering ceramic powder, is formed by pressing and sintering ceramic powders with minimum diameter of 0.1 mm-0.8 mm to provide a 3D color pattern slab formed by sintering ceramic powder, wherein:
the ceramic product includes clear cut ceramic sintered pattern regions having 2-10 various kinds of colors or different shades of a single or mixed colors;
at least 2 types of pattern regions each occupies 10%-90% of the total area of the ceramic product, in which at least each pattern region having at least one type of colored ceramic powder uniformly distributed in 80%-100% of the pattern area and 70%-100% from surface to the inside 70%-100% of the thickness of the ceramic product; and,
in a 1 mm-20 mm intersecting region between said two types of colored pattern regions, the mixture ratio of the different colored powder material between two different color pattern regions can reach from 1:50 to 50:50

2. Said 3D color pattern slab formed by sintering ceramic powder according to claim 1, wherein said slab comprises at least 2 types of colored pattern regions each occupies 10%-90% of the total slab region, and each pattern region including at least a kind of color powder within 80%-100% of the area of that pattern region is uniformly distributed from the surface to the inside of the slab in 85%-100% of its thickness.

3. Said 3D color pattern slab formed by sintering ceramic powder according to claim 1, wherein an intersecting region of 1-20 mm in between said 2 types of colored pattern regions has mixture ratio from 1:50 to 50:50 of the different color powders of said 2 colored pattern regions, and the independent color powder with minimum diameter of 0.1 mm 0.8 mm in the intersectional region is 50%-100%.

4. Said 3D color pattern slab formed by sintering ceramic powder according to claim 1, wherein in a 1 mm-50 mm intersecting region between said two types of colored pattern regions, the mixture ratio of the different colored powder material between two different color pattern regions can reach from 1:50 to 50:50.

5. Said 3D color pattern slab formed by sintering ceramic powder according to claim 1, wherein said pattern regions have 1-5 kinds of ceramic granules with minimum diameter of 1.5 mm-20 mm with volume of said ceramic granules accounts for 2%-80% of the total volume of said pattern region.

6. Said 3D color pattern slab formed by sintering ceramic powder according to claim 1, wherein said clear cut ceramic sintered pattern regions formed by 2-10 various colors or various shades of same color or mixed colors are provided with 1-5 kinds of granule patterns composed of colored ceramic powders with diameter between 3 mm-60 mm in a 3D space from the surface to the 90%-100% of the thickness of the slab.

7. Said 3D color pattern slab formed by sintering ceramic powder according to claim 1, wherein said pattern regions can be colored regions composed of powders of solid colors such as red, yellow, white, blue, black, green, purple, or brown, etc., or mixed colors by combination of various powders of more than one color, or combination of mixed color with solid colors.

8. Said 3D color pattern slab formed by sintering ceramic powder according to claim 7, wherein said ceramic product has a surface that can be either a unpolished surface or a polished surface.

9. Said 3D color pattern slab formed by sintering ceramic powder according to claim 8, wherein said surface of the ceramic product can be further combined with rough slip-proofing patterns having depth of dented sections of 0.1 mm-5 mm to form a pattern structure having a more stereoscopic appearance, and the protruded sections can have a surface either unpolished or polished.

10. Said 3D color pattern slab formed by sintering ceramic powder according to claim 8, wherein said colorized inorganic silicates can be of any of the follow geometric configurations: flat, cylindrical, curved, partially cylindrical, spherical, multi-angular, round, elongated, or square, etc.

11. Said 3D color pattern slab formed by sintering ceramic powder according to claim 2, wherein said pattern regions can be colored regions composed of powders of solid colors such as red, yellow, white, blue, black, green, purple, or brown, etc., or mixed colors by combination of various powders of more than one color, or combination of mixed color with solid colors.

12. Said 3D color pattern slab formed by sintering ceramic powder according to claim 3, wherein said pattern regions can be colored regions composed of powders of solid colors such as red, yellow, white, blue, black, green, purple, or brown, etc., or mixed colors by combination of various powders of more than one color, or combination of mixed color with solid colors.

13. Said 3D color pattern slab formed by sintering ceramic powder according to claim 4, wherein said pattern regions can be colored regions composed of powders of solid colors such as red, yellow, white, blue, black, green, purple, or brown, etc., or mixed colors by combination of various powders of more than one color, or combination of mixed color with solid colors.

14. Said 3D color pattern slab formed by sintering ceramic powder according to claim 5, wherein said pattern regions can be colored regions composed of powders of solid colors such as red, yellow, white, blue, black, green, purple, or brown, etc., or mixed colors by combination of various powders of more than one color, or combination of mixed color with solid colors.

15. Said 3D color pattern slab formed by sintering ceramic powder according to claim 6, wherein said pattern regions can be colored regions composed of powders of solid colors such as red, yellow, white, blue, black, green, purple, or brown, etc., or mixed colors by combination of various powders of more than one color, or combination of mixed color with solid colors.

16. Said 3D color pattern slab formed by sintering ceramic powder according to claim 11, wherein said ceramic product has a surface that can be either a unpolished surface or a polished surface.

17. Said 3D color pattern slab formed by sintering ceramic powder according to claim 12, wherein said ceramic product has a surface that can be either a unpolished surface or a polished surface.

18. Said 3D color pattern slab formed by sintering ceramic powder according to claim 13, wherein said ceramic product has a surface that can be either a unpolished surface or a polished surface.

19. Said 3D color pattern slab formed by sintering ceramic powder according to claim 14, wherein said ceramic product has a surface that can be either a unpolished surface or a polished surface.

20. Said 3D color pattern slab formed by sintering ceramic powder according to claim 15, wherein said ceramic product has a surface that can be either a unpolished surface or a polished surface.
